(19) United States
(12) Patent Application Publication
(10) Pub. No.: US 2026/0262809 A1
(43) Pub. Date: Sep. 10, 2026

(54) PROTECTIVE CASING FOR RINGS

(71) Applicant: ULTRAHUMAN HEALTHCARE PVT LTD, Bangalore South (IN)

(72) Inventors: Adhit SHET, Abu Dhabi (AE); Ritwik RAJ, Abu Dhabi (AE); Vatsal SINGHAL, Abu Dhabi (AE); Mohit KUMAR, Abu Dhabi (AE); Mainak MITRA, West Bengal (IN)

(73) Assignee: ULTRAHUMAN HEALTHCARE PVT LTD, Bangalore South (IN)

(21) Appl. No.: 19/666,344

(22) Filed: May 3, 2026

Related U.S. Application Data
(63) Continuation-in-part of application No. 19/344,323, filed on Sep. 29, 2025.
Application No. 19/344,323 is a continuation-in-part of application No. 19/054,172, filed on Feb. 14, 2025, now Pat. No. 12,672,702.

(51) Int. Cl. A44C 9/00; G06K 19/077

(52) U.S. Cl. CPC A44C 9/0092; G06K 19/077

(57) ABSTRACT

A protective casing for a ring is disclosed. The protective casing comprises a body constructed from stretchable silicone material that ensures robust protection against physical damage such as scratches, dents, and environmental wear. The protective casing further includes an NFC chip integrated with the body. The NFC chip is configured to securely store and transmit tokenized credentials. The protective casing further includes a conductive antenna, strategically arranged to optimize signal transmission with an external NFC-enabled terminal. The protective casing includes a first portion formed of a rigid material for securely encapsulating the NFC chip, and a second portion formed of a stretchable material for housing the conductive antenna.

### CROSS-REFERENCE TO RELATED APPLICATIONS

This application is a continuation-in-part of U.S. patent application Ser. No. 19/344,323, filed Sep. 29, 2025, which is a continuation-in-part of U.S. patent application Ser. No. 19/054,172, filed Feb. 14, 2025, content of which is incorporated by reference herein in its entirety.

### FIELD OF INVENTION

The present disclosure generally relates to the field of wearable technology. More specifically, the present disclosure is related to a protective casing for rings configured with swappable NFC modules and context profile switching for facilitating secure and contactless operations.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Wearable technology has experienced significant advancements, with smart rings emerging as a popular choice due to their compact form factor and multifunctionality. These smart rings typically incorporate features such as health monitoring, activity tracking, and seamless connectivity with other smart devices. However, the smart rings are inherently vulnerable to physical damage, including scratches, dents, and general wear and tear, resulting from regular usage. Current solutions for safeguarding these devices are inadequate, as they often fail to provide effective protection without impairing the functionality of the smart ring.

Concurrently, the demand for wearable devices that facilitate contactless payment has increased substantially. Conventional smart rings do not offer advanced features like contactless payments and security associated with the payments. Lack of such features limit usage of the smart rings. Further, there also does not lie a mechanism using which external means (i.e. external to the smart rings) for facilitating contactless payment could be secured.

Although wearable technology and NFC-enabled smart rings have advanced considerably in recent years, these devices still exhibit inherent design limitations such as fixed embedded NFC modules that cannot be replaced or upgraded, leading to functional obsolescence when the chip fails or newer protocols are introduced. Moreover, conventional smart ring designs lack adaptability to diverse use cases and do not support context-aware profile switching. Further, the conventional smart ring designs offer limited resistance to environmental factors such as moisture and mechanical stress. They also do not incorporate secure user authentication or intelligent context-based control, resulting in potential data security risks and reduced operational flexibility.

Therefore, a solution for above mentioned limitations is required.

### OBJECTS OF THE INVENTION

An object of the present disclosure is to provide a protective casing for rings that effectively safeguards the rings from physical damage such as scratches, dents, and wear-and-tear during regular usage.

Another object of the present disclosure is to incorporate a contactless payment functionality within the protective casing by integrating a Near Field Communication (NFC) chip and a conductive antenna to enable secure and efficient tokenized payment transactions.

Yet another object of the present disclosure is to provide a universally adaptable, modular design that integrates seamlessly with various kind of rings, ensuring full compatibility and preserving the original functionality and performance of the rings.

Yet another object of the present disclosure is to implement a secure payment system within the protective casing that utilizes advanced tokenization and encryption protocols, ensuring user data confidentiality and secure NFC-based transactions.

Yet another object of the present disclosure is to provide a multi-functional protective casing that combines physical protection with advanced payment capabilities, enhancing the utility of the rings in a cost-effective, practical, and user-friendly manner.

Yet another object of the present disclosure is to provide a modular housing structure that allows replacement or upgrading of NFC modules without replacing the entire ring, thereby extending device longevity and functional adaptability.

Yet another object of the present disclosure is to integrate biometric authentication or user verification functionality within the smart ring, enabling secure, user-specific activation of NFC operations.

Yet another object of the present disclosure is to enable context-aware switching of NFC profiles based on user input, gesture detection, or environmental context to support multiple applications.

### SUMMARY OF THE INVENTION

This summary is provided to introduce aspects related to the present disclosure of protective casing for rings and the aspects are further described below in the detailed description. This summary is not intended to identify essential features of the claimed subject matter nor is it intended for use in determining or limiting the scope of the claimed subject matter.

In an embodiment of the present disclosure, a protective casing for ring is disclosed. The protective casing comprises a body adapted to wrap around a ring. The body comprises a slot formed within the body to receive and house an NFC (Near field Communication) chip. The NFC chip is configured to store tokenized credentials to facilitate communication with an external NFC-enabled terminal.

In an aspect of the present disclosure, the protective casing further comprises a conductive antenna integrated within the body and electrically connected with the NFC chip. The conductive antenna is configured to facilitate communication between the NFC chip and the external NFC-enabled terminal.

In another aspect of the present disclosure, the body comprises one or more sealing elements disposed around the slot to provide mechanical retention and environmental protection for the NFC chip.

In an aspect of the present disclosure, the body is configured to allow insertion and removal of the NFC chip without detaching the protective casing from the ring.

In an aspect of the present disclosure, the slot comprises a plurality of electrical contacts configured to establish an electrical connection between the NFC chip and the conductive antenna.

In an aspect of the present disclosure, the NFC chip dynamically switches between various operational profiles based on a user input or sensor data.

In an aspect of the present disclosure, the various operational profiles comprise at least one of payment transactions, access control, user authentication, healthcare monitoring, and environmental awareness modes.

In an aspect of the present disclosure, the body comprises a first portion formed of a rigid material and a second portion formed of a stretchable material.

In an aspect of the present disclosure, the slot is present in the first portion of the body.

In an aspect of the present disclosure, the slot is present in the second portion of the body.

In another aspect of the present disclosure, the conductive antenna is integrated on an inner surface of the second portion of the body.

In another aspect of the present disclosure, the conductive antenna is positioned within the second portion of the body.

In another aspect of the present disclosure, the NFC chip is a passive NFC chip.

In another aspect of the present disclosure, the conductive antenna is made using copper, aluminum, silver, or graphene.

In another aspect of the present disclosure, the conductive antenna is arranged in a circular or spiral configuration on an inner surface of the second portion of the body.

In another aspect of the present disclosure, the ring is of circular, hexagonal, or octagonal shape.

In another aspect of the present disclosure, the external NFC-enabled terminal is a payment terminal, and the NFC chip is configured to store and transmit tokenized payment credentials.

In another aspect of the present disclosure, the external NFC-enabled terminal is a smart lock, and the NFC chip is configured to store and transmit credentials for unlocking the smart lock.

In another embodiment of the present disclosure, a system for making contactless payment is disclosed. The system comprises a protective casing wrapped around a ring. The protective casing comprises a slot present within a portion of a body of the protective casing, where the slot houses an NFC chip configured to store tokenized payment credentials to facilitate communication with an external NFC-enabled terminal. The system further comprises a user device operable to communicate with the protective casing for storing the tokenized payment credentials in the NFC chip.

In another aspect of the present disclosure, the user device runs a software application accessible by a user for storing the payment credentials.

In another aspect of the present disclosure, the software application requires user authentication for allowing storing, updating, and replacement of the payment credentials.

In another aspect of the present disclosure, transactions of the payments are encrypted using one of Secure Hash Algorithm (SHA), Secure stock Layer (SSL) and Transport Layer Security (TLS).

### BRIEF DESCRIPTION OF THE DRAWINGS

The accompanying drawings constitute a part of the description and are used to provide further understanding of the present disclosure. The drawings illustrate exemplary embodiments of the present disclosure and, together with the description, serve to explain the principles of the present disclosure.

FIG. 1 illustrates a top perspective view of a protective casing for a ring, in accordance with an embodiment of the present disclosure.

FIG. 2 illustrates a perspective view of the protective casing wrapped around the ring, in accordance with an embodiment of the present disclosure.

FIGS. 3a and 3b illustrate top view and perspective view of the ring wrapped with protective casing respectively, in accordance with an embodiment of the present disclosure.

FIG. 4 illustrates a connection diagram of a system for making contactless payment, in accordance with an embodiment of the present disclosure.

FIG. 5 illustrates a perspective view of a protective casing for the ring, in accordance with another embodiment of the present disclosure.

FIG. 6 illustrates a connection diagram of a system for unlocking a smart lock, in accordance with an embodiment of the present disclosure.

FIGS. 7a and 7b illustrate a perspective view and top view of a protective casing for the ring respectively, in accordance with one embodiment of the present disclosure.

FIG. 7c illustrates a side perspective view of a protective casing for the ring respectively, in accordance with one embodiment of the present disclosure.

FIG. 7d illustrates a side view of a protective casing for the smart ring, in accordance with one embodiment of the present disclosure.

FIG. 7e illustrates a front view of a protective casing for the smart ring, in accordance with one embodiment of the present disclosure.

FIGS. 8a and 8b illustrate cross-sectional views of a protective casing for the smart ring, in accordance with one embodiment of the present disclosure.

A more complete understanding of the present disclosure and its embodiments thereof may be acquired by referring to the following description and the accompanying drawings.

### DETAILED DESCRIPTION OF THE INVENTION

Exemplary embodiments now will be described with reference to the accompanying drawings. The disclosure may, however, be embodied in many different forms and should not be construed as limited to the embodiments set forth herein; rather, these embodiments are provided so that this disclosure will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

It is to be noted, however, that the reference numerals used herein illustrate only typical embodiments of the present subject matter, and are therefore, not to be considered for limiting its scope, for the subject matter may admit to other equally effective embodiments.

The specification may refer to “an”, “another”, “one” or “some” embodiment(s) in several locations.

This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include operatively connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skills in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The detailed description includes specific details for the purpose of providing a thorough understanding of the present disclosure. However, it will be apparent to those skilled in the art that the present disclosure may be practiced without these specific details.

The present disclosure relates to a protective casing adapted to wrap around a ring. The protective casing is designed to enhance both physical protection and operational utility by integrating advanced payment capabilities. The protective casing comprise a body constructed from durable, stretchable silicone material that ensures robust protection against physical damage such as scratches, dents, and environmental wear. The protective casing further include a passive NFC chip integrated with the body, configured to securely store and transmit tokenized credentials. The protective casing further includes a conductive antenna, arranged in a circular or spiral configuration on an inner surface of the casing to facilitate efficient communication between the NFC chip and external NFC-enabled terminals. The protective casing is customizable in terms of design, offering options such as transparency or various colors to suit user preferences.

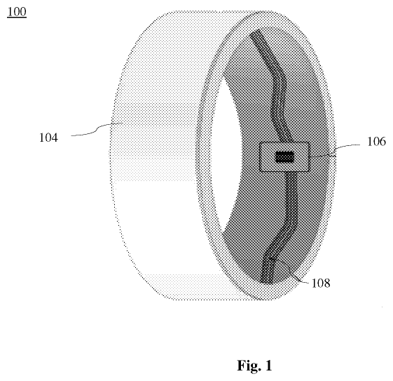

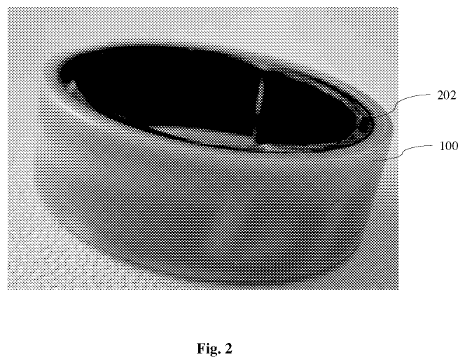

FIG. 1 illustrates a top perspective view of a protective casing 100 for a ring 202 (illustrated in FIG. 2), in accordance with an embodiment of the present disclosure. The ring 202 may comprises a protective casing 100 which is wrapped around whole body of the ring 202. The protective casing 100 may comprises a body 104 constructed from high-grade stretchable material like silicone, polyurethane or rubber. In one implementation, the protective casing 100 may comprise a body 104 constructed from a high-grade stretchable silicone material that is configured to envelop the ring 202 entirely. The silicone material is selected for its flexibility, durability, and resistance to physical damage, including scratches, impacts, and environmental factors such as moisture and dust. The elastic properties of the silicone material enable a snug and secure fit around the ring 202 and facilitates easy attachment and removal without causing damage to the ring 202 or the protective casing 100. Additionally, the protective casing 100 is customizable to be transparent, semi-transparent, and also available in various colors based on user preferences.

The protective casing 100 may further comprise an NFC chip 106 integrated within the body 104 of the protective casing 100. The NFC chip 106 is configured to operate in a passive mode means the NFC chip 106 harness power from electromagnetic field generated by an external NFC-enabled terminal. This feature eliminates the need for an internal power source making the ring 202 lightweight and efficient. The NFC chip 106 is configured to store tokenized credentials. In one implementation, the NFC chip 106 is configured to securely store tokenized payment credentials of users, which are encrypted for enhanced security.

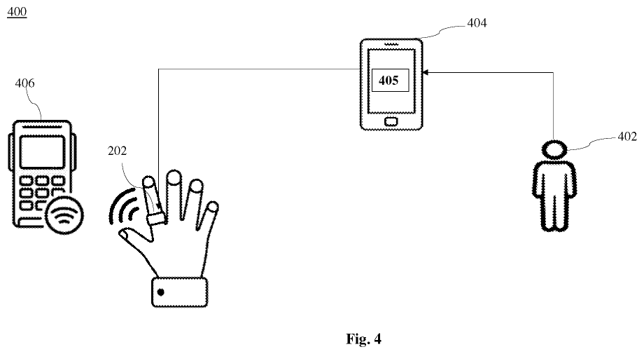

The protective casing 100 may further comprise a conductive antenna 108 integrated with the body 104 of the protective casing 100. The conductive antenna 108 may be constructed from copper, aluminum, silver, or graphene. In one implementation, the conductive antenna 108 is made of copper, due to its superior electrical conductivity and durability. The conductive antenna 108 is connected with the NFC chip 106 and integrated with the body 104 of the protective casing 100 and is arranged in a circular or spiral configuration along the inner surface. This specific design enhances efficiency the conductive antenna 108 by maximizing the surface area for signal transmission and ensuring consistent electromagnetic communication with the external NFC-enabled terminal. The conductive antenna 108 serves as a critical link between the NFC chip 106 and the external NFC-enabled terminal. The placement of the conductive antenna 108 within the protective casing 100 ensures protection against physical wear and tear, thereby enhancing its operational lifespan. The design of the conductive antenna 108 allows for efficient signal transmission without obstructing the ergonomic features of the ring 202, ensuring the ring 202 remains comfortable for extended use. In one implementation, during a transaction, the stored payment credentials of the users are transmitted to an external NFC-enabled payment terminal 406 (illustrated in FIG. 4), enabling a seamless and secure contactless payment process.

In one implementation, the NFC chip 106 and the conductive antenna 108 are strategically integrated along the inner surface of the protective casing 100. This configuration allows for ease of replacement or upgrade of these components without requiring the entire protective casing 100 to be discarded. The placement ensures direct and efficient electromagnetic coupling with the ring 202, optimizing communication with the external NFC-enabled payment terminal 406. The inner-surface integration also allows for simplified maintenance and the flexibility to incorporate advanced chip or antenna designs in future iterations. Additionally, this arrangement facilitates quick replacement of worn or outdated components, contributing to the sustainability and adaptability of the protective casing 100 while maintaining its ergonomic and protective functionalities.

In another implementation, the NFC chip 106 and the conductive antenna 108 are securely positioned within the protective casing 100. This arrangement ensures that these components are entirely encapsulated within the body 104 of the casing, providing superior protection against environmental factors, such as moisture, dust, and mechanical damage. The central positioning enhances the durability of the protective casing 100 by minimizing exposure to external elements, thereby prolonging the operational lifespan of the chip and antenna. The encapsulation also enables seamless integration into the overall design of the casing, ensuring that the ergonomic properties of the ring 202 are preserved.

FIG. 2 illustrates a perspective view of the protective casing 100 wrapped around the ring 202, in accordance with an embodiment of the present disclosure. The protective casing 100 is constructed from high-grade stretchable silicone material. The silicone made protective casing 100 is designed to snugly envelop the ring 202 and provides a durable shield against physical damage such as scratches, dents, wear from regular use and ensures long-term safety of the ring 202. Further the protective casing 100 is integrated with the NFC chip 106 strategically placed to facilitate seamless communication with the external NFC-enabled terminal. Further, the conductive antenna 108 is encircled around the inner surface of the protective casing 100 which enhances signal strength and ensures reliable data transmission between the NFC chip 106 and the external NFC-enabled terminal.

Additionally, the flexibility of the protective casing 100 supports universal compatibility with various types of rings, and various shapes of ring like circular, hexagonal or octagonal, making it adaptable to multiple form factors. The protective casing 100 also includes customization options that allows the casing to be manufactured in transparent, semi-transparent, or colorful finishes based on diverse user preferences. The ergonomic design of the protective casing 100 allows easy attachment and detachment from the ring 202 without damaging or obstructing original functionalities of the ring 202 such as health tracking or activity monitoring. The silicone protective casing provides both robust physical protection and advanced capabilities in a compact, user-friendly design.

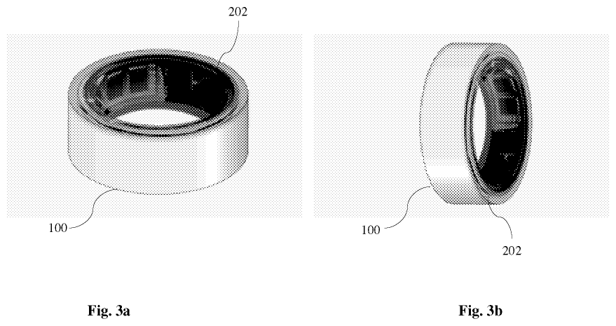

FIGS. 3a and 3b illustrate top view and perspective view of the ring 202 wrapped with protective casing 100 respectively, in accordance with an embodiment of the present disclosure. The top view provides a clear depiction of the ring 202 wrapped within the protective casing 100, highlighting the circular arrangement of the embedded conductive antenna 108 along outer circumference. This view emphasizes the seamless integration of the protective casing 100 with the ring 202 and also ensures a snug and secure fit. The perspective view offers a three-dimensional representation, showcasing the ergonomic design and structural features of the protective casing 100, including the placement of the NFC chip 106 and the overall form factor.

FIG. 4 illustrates a connection diagram of a system 400 for making contactless payment, in accordance with an embodiment of the present disclosure. The system 400 comprises the protective casing 100 wrapped around the ring 202. The protective casing 100 may comprise the body 104 constructed from high-grade stretchable material like silicone, polyurethane or rubber. In one implementation, the protective casing 100 may comprise a body 104 constructed from a high-grade stretchable silicone material that is configured to envelop the ring 202 entirely. The silicone material is selected for its flexibility, durability, and resistance to physical damage, including scratches, impacts, and environmental factors such as moisture and dust. The elastic properties of the silicone material enable a snug and secure fit around the ring 202 and facilitates easy attachment and removal without causing damage to the ring 202 or the protective casing 100. Additionally, the protective casing 100 is customizable to be transparent, semi-transparent, and also available in various colors based on user preferences.

The protective casing 100 may further comprise an NFC chip 106 integrated within the body 104 of the protective casing 100. The NFC chip 106 is configured to operate in a passive mode means the NFC chip 106 harness power from the electromagnetic field generated by an external NFC-enabled payment terminal 406. This feature eliminates the need for an internal power source making the ring 202 lightweight and efficient. The NFC chip 106 is further configured to securely store tokenized payment credentials of the users 402, which are encrypted for enhanced security. During a transaction, the stored credentials of the users 402 are transmitted to the external NFC-enabled payment terminal 406, enabling a seamless and secure contactless payment process.

The protective casing 100 may further comprise a conductive antenna 108 integrated with the body 104 of the protective casing 100. The conductive antenna is 108 constructed from copper, aluminum, silver, or graphene. In one implementation the conductive antenna 108 is made of copper, due to its superior electrical conductivity and durability. The conductive antenna 108 is connected with the NFC chip 106 and integrated with the body 104 of the protective casing 100 and is arranged in a circular or spiral configuration along the inner circumference. This specific design enhances efficiency the conductive antenna 108 by maximizing the surface area for signal transmission and ensuring consistent electromagnetic communication with the NFC-enabled payment terminal 406. The conductive antenna 108 serves as a critical link between the NFC chip 106 and NFC-enabled payment terminal 406. The placement of the conductive antenna 108 within the protective casing 100 ensures protection against physical wear and tear, thereby enhancing its operational lifespan. The design of the conductive antenna 108 allows for efficient signal transmission without obstructing the ergonomic features of the ring 202, ensuring the ring 202 remains comfortable for extended use.

In one implementation, the NFC chip 106 and the conductive antenna 108 are strategically integrated along the inner surface of the protective casing 100. This configuration allows for ease of replacement or upgrade of these components without requiring the entire protective casing 100 to be discarded. The placement ensures direct and efficient electromagnetic coupling with the ring 202, optimizing communication with the external NFC-enabled payment terminal 406. The inner-surface integration also allows for simplified maintenance and the flexibility to incorporate advanced chip or antenna designs in future iterations. Additionally, this arrangement facilitates quick replacement of worn or outdated components, contributing to the sustainability and adaptability of the protective casing 100 while maintaining its ergonomic and protective functionalities.

In another implementation, the NFC chip 106 and the conductive antenna 108 are securely positioned within the protective casing 100. This arrangement ensures that these components are entirely encapsulated within the body 104 of the casing, providing superior protection against environmental factors, such as moisture, dust, and mechanical damage. The central positioning enhances the durability of the protective casing 100 by minimizing exposure to external elements, thereby prolonging the operational lifespan of the chip and antenna. The encapsulation also enables seamless integration into the overall design of the casing, ensuring that the ergonomic properties of the ring 202 are preserved.

Further the system may comprise a user device 404. The user device 404 may include but is not limited to, smartphone, tablet, PC, display screen. The user device 404 acts as an intermediary for configuring the ring 202 with payment credentials. The user device 404 is equipped with an NFC module 405 that establishes a secure short-range communication link with the NFC chip 106 integrated with the body 104 of the protective casing 100. The NFC module 405 within the user device 404 establishes a short-range wireless connection with the NFC chip 106 integrated with the body 104 of the protective casing 100. The user device 404 further includes a software application for performing one or more tasks described successively. For instance, the user device 404 may receive the payment credentials from the user 402 via the software application. The software application may also perform tokenization that converts sensitive payment details of the user 402 into unique, encrypted tokens. These tokens are transaction-specific, ensuring that they cannot be reused or decrypted even if intercepted. After the generation of tokenized credentials, the tokenized credentials are transmitted to the NFC chip 106 integrated with the body 104 of the protective casing 100 using encrypted NFC communication protocols, ensuring data integrity and preventing unauthorized access. The software application requires user authentication for allowing storing, updating, and replacement of the payment credentials.

The system 400 may further include an external NFC-enabled payment terminal 406. When the ring 202 is brought within proximity to the external NFC-enabled payment terminal 406 typically within a range of a few centimeters. The external NFC-enabled payment terminal 406 initiates the process by generating a low-frequency electromagnetic field. The low-frequency electromagnetic field is emitted through an NFC antenna integrated within the terminal, designed to power NFC devices in its vicinity. The conductive antenna 108 integrated with the protective casing 100 of the ring 202 is configured to capture this electromagnetic field efficiently. The conductive antenna 108 which may be constructed from materials such as copper or similar high-conductivity metals, is strategically designed in a circular or spiral configuration to optimize field capture. The low-frequency electromagnetic field is then directed by the conductive antenna to activate the NFC chip 106 integrated into the protective casing 100.

Upon activation, the NFC chip 106 retrieves the tokenized payment credentials, which have been pre-configured and securely transmitted from the user device 404 during the setup phase. The tokenization process ensures that the credentials are encrypted, unique to the transaction, and devoid of sensitive user data such as the actual card number or personal identification information. The process prevents unauthorized access of the sensitive user data and minimizes risks associated with data breaches or interception during transmission. The NFC-enabled payment terminal 406 processes the tokenized payment credentials by communicating with a payment network or acquirer bank associated with the transaction upon receiving the tokenized payment credentials.

The payment network or the acquirer bank verifies the token present in the tokenized payment credentials by decrypting the token using a secure key associated with the tokenization process. The decrypted token is matched against stored payment credentials of the user 402 in the secure network environment to confirm its authenticity and validity. If the payment credentials are validated successfully, the payment network authorizes the transaction and sends an approval message back to the external NFC-enabled payment terminal 406. The external NFC-enabled payment terminal 406 completes the transaction by processing the payment and providing confirmation to the user 402 through a visual or auditory signal, such as a beep, screen notification, or printed receipt. The payment network or the acquirer bank also provide information about the status of the payment to the user 402 via the software application. The software application may provide payment transaction history of the user 402 including date, time, amount, and merchant name. The transactions of the payments are encrypted using one of Secure Hash Algorithm (SHA), Secure stock Layer (SSL) and Transport Layer Security (TLS).

FIG. 5 illustrates a perspective view of a protective casing 500 for the ring 202, in accordance with another embodiment of the present disclosure. The protective casing 500 may comprise a body 504 that is adapted to wrap around the outer surface of the smart ring 202. The body 504 includes a first portion 506 and a second portion 508, each serving different mechanical and functional purposes. The first portion 506 of the body 504 is formed of a rigid material to house the NFC chip 106. The rigid material may be selected from a group comprising of High-Density Polyethylene (HDPE), Acrylonitrile Butadiene Styrene (ABS), Polycarbonate (PC), and glass. The rigid material is selected based on required mechanical strength, thermal stability, and resistance to environmental degradation.

During manufacturing, the rigid material may be poured, in a molten state, around the NFC chip 106. Upon solidification, the rigid material may completely surround the NFC chip 106. Such secure positioning ensures electrical stability and minimizes the risk of dislocation or damage due to handling, shock, or thermal cycling during use. The NFC chip 106 housed within the first portion 506 is operable in a passive mode, harvesting energy from an electromagnetic field generated by the external NFC-enabled terminal 406. The NFC chip 106 is further configured to securely store tokenized credentials, which may be written or updated using the user device 404 operating a companion software application. In one implementation, the software application requires user authentication such as biometric input or password entry before allowing any modification or overwriting of stored credentials.

The second portion 508 of the body 504 is formed of a stretchable material that facilitates elastic deformation and conformal engagement with the surface of the ring 202. The stretchable material may include, but is not limited to, silicone, polyurethane (PU), or rubber. Such elastic nature allows the second portion 508 to be easily stretched and slipped over the ring 202, enabling secure attachment while accommodating tolerances in ring geometry or size. The second portion 508 enhances user comfort and enables the protective casing 500 to be adaptable to smart rings having different shapes, including circular, hexagonal, or octagonal cross-sections.

Further the conductive antenna 108 is integrated with the second portion 508 of the body 504 of the protective casing 500. The conductive antenna 108 may be constructed from copper, aluminum, silver, or graphene. In one implementation, the conductive antenna 108 is made of copper, due to its superior electrical conductivity and durability. The conductive antenna 108 is connected with the NFC chip 106 and integrated with the second portion 508 of the body 504 of the protective casing 500 and is arranged in a circular or spiral configuration along the inner surface. This specific design enhances efficiency the conductive antenna 108 by maximizing the surface area for signal transmission and ensuring consistent electromagnetic communication with the external NFC-enabled terminal. The conductive antenna 108 serves as a critical link between the NFC chip 106 and the external NFC-enabled terminal 406. The placement of the conductive antenna 108 within the protective casing 500 ensures protection against physical wear and tear, thereby enhancing its operational lifespan. The design of the conductive antenna 108 allows for efficient signal transmission without obstructing the ergonomic features of the ring 202, ensuring the ring 202 remains comfortable for extended use. In one implementation, the NFC chip 106 is configured to securely store tokenized payment credentials of users, which are encrypted for enhanced security. During a transaction, the stored payment credentials of the users are transmitted to the external NFC-enabled payment terminal 406, enabling a seamless and secure contactless payment process.

In one implementation, the conductive antenna 108 is strategically integrated along the inner surface of the second portion 508 of the protective casing 500. Such type of configuration allows for ease of replacement or upgrade of the conductive antenna 108 without requiring the entire protective casing 500 to be discarded. The placement ensures direct and efficient electromagnetic coupling with the ring 202, optimizing communication with the NFC-enabled payment terminal 406. The inner-surface integration also allows for simplified maintenance and the flexibility to incorporate advanced antenna designs in future iterations. Additionally, this arrangement facilitates quick replacement of worn or outdated components, contributing to the sustainability and adaptability of the protective casing 500 while maintaining its ergonomic and protective functionalities.

In another implementation, the conductive antenna 108 is securely positioned within the second portion 508 of the protective casing 500. This arrangement ensures that the conductive antenna 108 are entirely encapsulated within the second portion 508 of the protective casing 500, providing superior protection against environmental factors, such as moisture, dust, and mechanical damage. The central positioning enhances the durability of the protective casing 500 by minimizing exposure to external elements, thereby prolonging the operational lifespan of the antenna. The encapsulation also enables seamless integration into the overall design of the casing, ensuring that the ergonomic properties of the ring 202 are preserved.

The first portion 506 and the second portion 508 of the body 504 are permanently attached using a suitable bonding technique. The bonding technique may include, but not limited to adhesive bonding, and thermal fusion. The selected method of attachment ensures a secure, water-resistant, and mechanically robust interface between the dissimilar materials. The resulting unitary structure provides both flexibility and strength, supporting functional integration without compromising wearability or structural stability. The joining interface is designed to withstand repeated mechanical stresses associated with ring flexion, user handling, and environmental exposure.

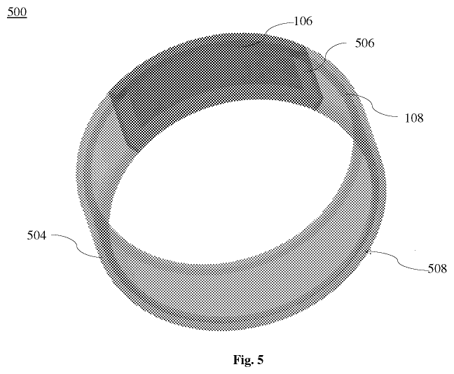

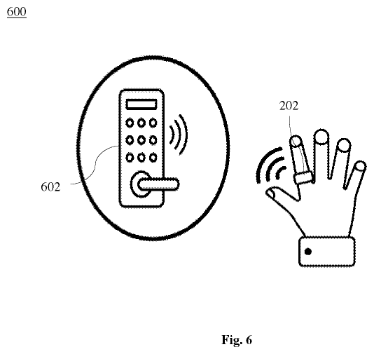

FIG. 6 illustrates a connection diagram of a system 600 for unlocking a smart lock 602, in accordance with an embodiment of the present disclosure. The smart lock 602 may be an NFC-enabled. The system 600 comprises the protective casing 500 disposed around the ring 202. The NFC chip 106 present within the first portion 506 is configured to store encrypted access control credentials of the smart lock 602 and is operable in a passive mode to initiate secure wireless communication with the smart lock 602. The smart lock 602 may be implemented as part of a smart locking system integrated into physical access points such as doors, windows, safes, or other controlled enclosures.

During operation, when the ring 202 is brought within a defined proximity of the smart lock 602, the conductive antenna 108 facilitates electromagnetic coupling, allowing the stored access credentials from the NFC chip 106 to be transmitted to the smart lock 602 over a secure communication channel. A microcontroller present in the smart lock 602 may validate the access credentials and unlock the smart lock 602 upon success validation. The system 600 supports secure, touchless access control and may be further integrated with backend authentication protocols to enhance security and auditability.

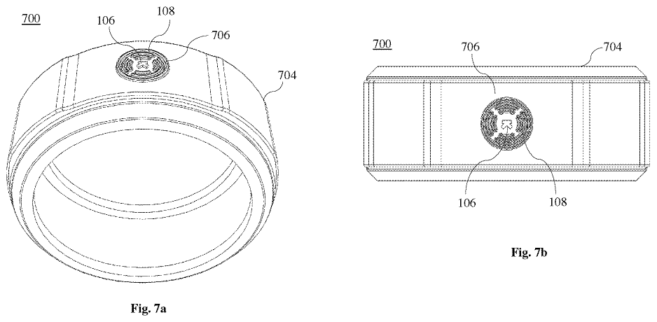

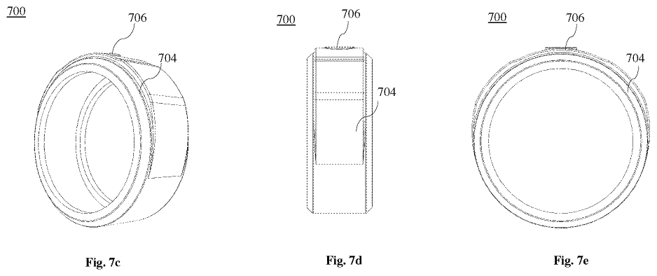

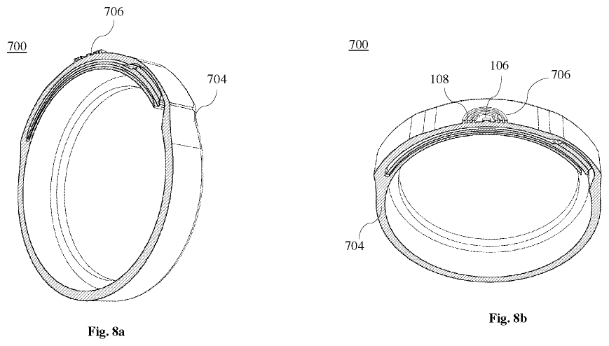

FIGS. 7a, 7b, 7c, 7d and 7e illustrates a perspective view, a top view, a side perspective view, a side view and a front view of a protective casing 700 for the ring 202 respectively, in accordance with one embodiment of the present disclosure and FIGS. 8a and 8b illustrates cross-sectional views of the protective casing 700 for the smart ring 202, in accordance with one embodiment of the present disclosure. Referring to FIG. 7a-FIG. 8e, different views of the protective casing 700 are disclosed. The protective casing 700 comprises a body 704 adapted to wrap around the ring 202 and serve as an outer sleeve for housing electronic components, including the NFC chip 106 and the conductive antenna 108. The structure is designed to enable modular integration of NFC functionality within a compact wearable form factor.

The body 704 includes a slot 706 present within a portion of the body 704 and configured to house the NFC chip 106. The NFC chip 106 is configured to store tokenized credentials, such as payment, access data or authentication codes which can be securely transmitted to the external NFC-enabled terminals 406, 602. The slot 706 provides accurate alignment and mechanical stability for the NFC chip 106 while ensuring electrical connectivity with the conductive antenna 108 integrated within the body 704.

In one implementation, the NFC chip 106 may facilitate communication with the external NFC-enabled terminal 406, 602 without requiring a designated conductive antenna, thereby enabling a simplified configuration in which NFC functionality is provided through the NFC chip 106 housed within the slot 706. In another implementation, the protective casing 700 may include a conductive antenna 108 integrated within the body 704 and electrically connected to the NFC chip 106. The conductive antenna 108 may enhance communication between the NFC chip 106 and the external NFC-enabled terminal 406, 602.

In one embodiment, the slot 706 may be positioned within the first portion 506 of the body 504, 704 made of a rigid material such as High-Density Polyethylene (HDPE), Acrylonitrile Butadiene Styrene (ABS), Polycarbonate (PC), or glass. The placement of the slot 706 in rigid region provides enhanced mechanical protection and dimensional stability to the NFC chip 106, ensuring that the NFC chip 106 remains securely positioned during repeated wear and handling. The rigid enclosure further protects the NFC chip 106 against bending or impact stress, thereby maintaining electrical integrity and consistent signal performance during NFC communication.

The first portion 506 of the body 504, 704 may further include one or more sealing elements disposed around the slot 706 to provide additional mechanical retention and environmental protection for the NFC chip 106. The sealing elements prevent dust, moisture, and other contaminants from entering the slot 706 and ensure long-term durability of the protective casing 500, 700. The sealing structure also ensures that the NFC chip 106 remains securely positioned within the slot 706 during regular usage. The one or more sealing elements may include silicone gaskets, over-molded lips, or thermoplastic elastomer (TPE) barriers.

In another embodiment, the NFC chip 106 may be positioned within a pocket sleeve formed in the second portion 508 of the body 504, 704 formed of a stretchable material. The stretchable material may be made of silicone, polyurethane (PU), or rubber. The stretchable material may comprise a bi-layer structure in which the NFC chip 106 is securely housed between an inner and an outer stretchable layer. The pocket sleeve allows simple placement and retention of the NFC chip 106 without permanent attachment, enabling easy assembly and replacement while maintaining comfort and flexibility for the user 402. This configuration ensures that the electronic components are safely embedded within the stretchable region of the protective casing 500, 700 while preserving user comfort during prolonged wear.

In one embodiment, the slot 706 includes a plurality of electrical contacts disposed along its inner surface. The plurality of electrical contacts is configured to establish an electrical connection between the NFC chip 106 and the conductive antenna 108. The electrical contacts may be spring-loaded or flexible conductive terminals configured to ensure stable signal transmission and to maintain reliable engagement during the use of the ring 202. Upon insertion of the NFC chip 106, the contacts automatically engage corresponding terminal pads on the NFC chip 106, allowing signal and power continuity without requiring permanent bonding. Such modular interface enables the NFC chip 106 to be easily inserted, removed, or replaced by the user 402 or service technician, thereby facilitating functional upgrades, maintenance, or personalization without disassembling or detaching the protective casing 700 from the ring 202.

Further, this feature allows the user 402 to swap functional modules such as a payment chip, access-control chip, or healthcare-monitoring chip while maintaining the same physical casing. The modular approach supports both standardized NFC modules and custom chip configurations, enabling manufacturers to update firmware or security protocols by replacing only the NFC chip 106 rather than the entire ring 202.

The conductive antenna 108 is integrated within the body 704 and electrically connected to the NFC chip 106. The conductive antenna 108 may be made of copper, aluminum, silver, or graphene and may be arranged in a circular or spiral configuration. The conductive antenna 108 facilitates communication between the NFC chip 106 and the external NFC-enabled terminal for performing secure data transmission.

It must be understood that the ring 202 covered by the protective casing 100, 500, 700 may include one or more sensors configured to monitor one or more parameters associated with the user 402 wearing the ring 202. The one or more parameters may include at least one of temperature, heart rate, motion, gesture, skin conductivity, hydration level, biometric identity, and ambient environmental condition.

In one embodiment, the sensors integrated within the ring 202 may include a temperature sensor configured to detect variations in the user's skin or environmental temperature, a motion sensor configured to track finger or hand movement, and a biometric sensor configured to capture user-specific physiological patterns such as pulse rhythm or skin conductivity. The data obtained from these sensors is transmitted to the NFC chip 106, which processes or forwards the data for authentication, profile selection, or contextual operation.

The NFC chip 106 is configured to dynamically switches between various operational profiles based on a user input or sensor data. The various operational profiles may include at least one of payment transactions, access control, user authentication, healthcare monitoring, and environmental awareness modes. The dynamic switching allows the ring 202 to intelligently modify its function in real time according to detected activity or contextual conditions, thereby enabling the ring 202 to perform multiple independent roles in a seamless and context-aware manner.

In one implementation, when the user 402 brings the ring 202 near an NFC-enabled payment terminal 406, the NFC chip 106 automatically activates a payment profile. The payment profile enables transmission of tokenized payment credentials to the terminal through the conductive antenna 108, thereby completing a secure transaction. Once the transaction is completed and no further proximity with a payment terminal is detected, the NFC chip 106 reverts to an idle or neutral profile to conserve energy and maintain security.

In another implementation, when the one or more sensors detect that the user 402 is in proximity to a registered smart lock, the NFC chip 106 switches to an access control profile. In this profile, the NFC chip 106 transmits stored access credentials to the smart lock 602, allowing automatic unlocking or secure entry. The switch to this profile may be triggered by a motion pattern such as a hand raise, a specific gesture, or proximity detection through the antenna field response.

In another implementation, the one or more sensors integrated within the ring 202 may detect biometric identity of the user 402 prior to activating any communication profile. In this scenario, the NFC chip 106 remains in a locked state until user identity is verified. Upon authentication, the NFC chip 106 activates an authentication profile, enabling secure login, device pairing, or user verification in a connected ecosystem.

In another implementation, when the temperature and motion sensors present in the ring detect elevated body temperature or repetitive activity patterns, the NFC chip 106 may switch to a healthcare monitoring profile. In this profile, the NFC chip 106 collaborates with the sensors to record physiological data such as heart rate, hydration level, or activity level, and may transmit this data to a paired user device for health tracking. In a healthcare variant, the NFC chip 106 is further configured to prioritize encrypted medical data storage and initiate automatic profile switching based on emergency context, such as detection of abnormal vital signs or sudden inactivity, thereby enabling rapid transmission of critical health information to authorized systems or emergency responders. The same ring can thus function as both a payment accessory and a wellness tracker, based on contextual sensor inputs.

The operational profiles may also be changed manually through user-defined input gestures. For instance, a double-tap gesture on surface of the ring 202 may signal the NFC chip 106 to switch from payment mode to access mode, while a rotational movement or long press gesture may trigger a switch to a healthcare monitoring profile. The sensors integrated in the ring 202 capture these gesture-based inputs and transmit corresponding control signals to the NFC chip 106, enabling intuitive and seamless switching between modes.

The present disclosure demonstrates significant technical advancement by seamlessly integrating a passive NFC chip and a conductive antenna within a protective casing for rings. The invention enables secure, efficient, and user-friendly contactless payment functionality. The conductive antenna, embedded in the protective casing in a circular or spiral arrangement, optimizes signal transmission between the NFC chip and external NFC-enabled payment terminal. The use of tokenized payment credentials, in conjunction with robust encryption protocols, ensures a high level of transaction security, safeguarding user data. Furthermore, the protective casing constructed from durable and stretchable silicone, provides superior resistance to physical damage, environmental wear, and scratches, while maintaining the ring's core functionalities. This invention also incorporates user-centric features, including ergonomic design, universal compatibility, and customization options, thereby delivering a comprehensive solution that merges advanced technology with practicality, representing a significant enhancement over existing wearable and payment systems.

Although implementations of protective casing for rings, for making contactless payment have been described in language specific to structural features and/or methods, it is to be understood that the appended claims are not necessarily limited to the specific features or methods described. Rather, the specific features and methods are disclosed as examples of implementations protective casing for rings, for making contactless payment.

The invention has been described above with reference to numerous embodiments and specific examples. Many variations will suggest themselves to those skilled in this art in light of the above detailed description. All such obvious variations are within the full intended scope of the appended claims.

1. A protective casing comprising:
a body adapted to wrap around a ring, wherein the body comprises a slot formed within the body and configured to receive and house an NFC chip, and
wherein the NFC chip is configured to store tokenized credentials to facilitate communication with an external NFC-enabled terminal.

2. The protective casing as claimed in claim 1, the protective casing further comprises a conductive antenna integrated within the body and electrically connected to the NFC chip (106), wherein the conductive antenna is configured to facilitate the communication between the NFC chip and the external NFC-enabled terminal.

3. The protective casing as claimed in claim 1, wherein the body comprises one or more sealing elements disposed around the slot to provide mechanical retention and environmental protection for the NFC chip.

4. The protective casing as claimed in claim 1, wherein the body is configured to allow insertion and removal of the NFC chip without detaching the protective casing from the ring.

5. The protective casing as claimed in claim 1, wherein the slot comprises a plurality of electrical contacts configured to establish an electrical connection between the NFC chip and the conductive antenna.

6. The protective casing as claimed in claim 1, wherein the NFC chip dynamically switches between various operational profiles based on user input or sensor data.

7. The protective casing as claimed in claim 1, wherein the various operational profiles comprise at least one of payment transactions, access control, user authentication, healthcare monitoring, and environmental awareness modes.

8. The protective casing as claimed in claim 1, wherein the body comprises a first portion formed of as a rigid material and a second portion formed of a stretchable material.

9. The protective casing as claimed in claim 1, wherein the slot is formed in the first portion of the body.

10. The protective casing as claimed in claim 1, wherein the slot is formed in the second portion of the body.

11. The protective casing as claimed in claim 2, wherein the conductive antenna is integrated on an inner surface of the second portion of the body.

12. The protective casing as claimed in claim 2, wherein the conductive antenna is positioned within the second portion of the body.

13. The protective casing as claimed in claim 1, wherein the NFC chip is a passive NFC chip.

14. The protective casing as claimed in claim 2, wherein the conductive antenna is made using copper, aluminum, silver, or graphene.

15. The protective casing as claimed in claim 2, wherein the conductive antenna is arranged in a circular or spiral configuration on an inner surface of the second portion of the body.

16. The protective casing as claimed in claim 1, wherein the ring is of circular, hexagonal, or octagonal shape.

17. The protective casing as claimed in claim 1, wherein the external NFC-enabled terminal is an NFC enabled payment terminal, and the NFC chip is configured to store and transmit tokenized payment credentials.

18. The protective casing as claimed in claim 1, wherein the external NFC-enabled terminal is a smart lock, and the NFC chip is configured to store access credentials for unlocking the smart lock.

19. A system for making contactless payments, the system comprising:
a protective casing wrapped around a ring, wherein the protective casing comprises:
a body adapted to receive and house an NFC chip within a slot, wherein the NFC chip is configured to store tokenized payment credentials to facilitate communication with an external NFC-enabled terminal; and
a user device (202) operable to communicate with the protective casing for storing the tokenized payment credentials in the NFC chip.

20. The system as claimed in claim 19, wherein the user device runs a software application accessible by a user for storing the payment credentials.

21. The system as claimed in claim 19, wherein the software application requires user authentication for storing, updating, and replacement of the payment credentials.

22. The system as claimed in claim 19, wherein transactions of the payments are encrypted using one of Secure Hash Algorithm (SHA), Secure stock Layer (SSL), and Transport Layer Security (TLS).

23. A method for facilitating contactless payments, the method comprising:
receiving, via a software application, one or more payment credentials from a user;
tokenizing the payment credentials; and
transmitting, via an NFC module, tokenized payment credentials to an NFC chip for making a payment, wherein the NFC chip is housed within a slot of a body of a protective casing for a ring.

24. The method as claimed in claim 23, wherein the software application encrypts the payment credentials before tokenizing.
